(19) United States
(12) Patent Application Publication
(10) Pub. No.: US 2018/0244471 A1
(43) Pub. Date: Aug. 30, 2018

(54) TRANSPORT UNIT OF AN OVERHEAD CONVEYOR SYSTEM, HAVING A BUFFER ELEMENT

(71) Applicant: FERAG AG, CH-8340 HINWIL (CH)

(72) Inventors: Alex KELLER, Wagen (CH); Erwin STAUBER, Grüt (CH)

(73) Assignee: FERAG AG, CH-8340 HINWIL (CH)

(21) Appl. No.: 15/553,490

(22) PCT Filed: Mar. 2, 2016
(86) PCT No.: PCT/EP2016/054469

§ 371 Date: Aug. 24, 2017

(30) Foreign Application Priority Data
Mar. 2, 2015 (CH) 00326/15
Feb. 5, 2016 (CH) 00158/16

(51) Int. Cl. B65G 9/00; B65G 1/08

(52) U.S. Cl. CPC B65G 9/006; B65G 1/08

(57) ABSTRACT

The invention relates to a transport unit (1, 1a-d, 1a′-d′) of an overhead conveyor system (2, 2′, 2″), comprising an elastically deformable buffer element (11, 11′, 11″, 11a-d, 11a′-d′), which is designed to store deformation energy when under load and to release same when no longer under load.

### BACKGROUND OF THE INVENTION

### Field of the Invention

The present invention lies in the area of the conveying of products. It relates to a transport unit of an overhead conveyor device comprising a buffer element and an overhead conveyor device as well as a method for operating an overhead conveyor device.

### Discussion of Related Art

In conveyor systems, in particular in intra-logistics, use is frequently made of transport units, which each take up and transport a product to be conveyed. The transport units are moved, or driven, in different ways on conveyor lines of the conveyor devices, wherein different solutions for accelerating and/or guiding and/or decelerating the transport units are desired depending on the given intra-logistical requirements. Various drive solutions in this regard are known from the prior art, amongst others chain drives or transport units of conveyor devices driven by gravity.

DE 10 2008 057630 A1 describes an order-picking system with a rack, with conveying technology for transporting order containers through the system, wherein articles are picked along the rack with the aid of an order-picking carriage out of warehouse loading means into order loading means according to a picking order. The picking order usually comprises a multiplicity of different articles, which are requested in different numbers. The order-picking carriage can be supplied with energy via a conductor line in a guide rail on the rack, via a trailing cable or by an energy storage unit integrated into the carriage, e.g. a battery, an accumulator or a super-capacitor. The charging of the energy storage unit can for example take place on site, where the order container is exchanged with the conveying technology. In an embodiment, the order-picking carriage is moved by means of an external drive, preferably with an externally driven toothed belt.

DE 10 2012 015040 A1 describes a gravity conveying system, in particular an overhead conveyor, with a fixed guide rail arranged in a conveying plane, with a plurality of carriages movable along this guide rail in a conveying direction and with a separating device arranged in an end section of the guide rail for the transfer, one at a time, of the carriages banked up in the end section of the guide rail under the effect of gravity to a rail unit movable relative to the end section of the guide rail, wherein the separating device can be transferred, by the movement of the rail unit into a defined transfer position relative to the end section of the guide rail, from a first position, in which the first holding element is engaged with the first carriage lying foremost in the conveying direction, into a second position, in which the first holding element releases the first carriage and a second holding element is engaged with the second carriage arranged behind the first carriage in the conveying direction. A return device is assigned to the separating device, by means of which return device the separating device can be automatically returned from the second position into the first position after the transfer of the, in each case, first carriage to the rail unit from the transfer position. The return device is constituted as an energy storage unit, for example as a spring.

EP 1 299 298 B1 describes a method and a device for conveying objects on a conveying line, wherein the objects are held individually and conveyed along the conveying line behind one another and at least to a limited extent independently of one another and wherein the objects run through a buffer store during the conveying along the conveying line. To implement a buffer store on a conveying line, drives (motor drives or gravity) are provided, with which holding elements are conveyed at a constant or variable speed and with constant or variable spacings to the tail end of the buffer store and at a variable speed and with minimum spacings through the buffer store (conveying and buffer drive) and with which holding elements released at the head end of the buffer store are conveyed away from the buffer store (conveying-away drive). Gravity can at least in part be used as a conveying drive, buffer drive and conveying-away drive. The conveying drive, buffer drive and conveying-away drive can be constituted as separate drives or as one or two drives, wherein at least one of the drives takes over more than one of the aforementioned drive functions.

The solutions from the prior art have in common the fact that the drive of the transport units always has to be supplied with energy externally, which reduces flexibility with regard to the requirements mentioned at the outset.

### SUMMARY OF THE INVENTION

Depending on the nature of the conveying and the products to be conveyed, a high degree of flexibility in the speed of the transport units is desired with overhead conveyor devices, in particular in intra-logistics. For example, the required conveying speed may be different in given sections of the conveying line of the overhead conveyor device, depending on the specific procedure in the section of the conveying line concerned. Specific overhead conveyor devices provide accumulation lines for example, in which the transport units are conveyed at reduced speed or are even temporarily at rest.

The transport units can be moved independently of one another or can be coupled together.

These aspects make demands on the acceleration, deceleration or driving of the transport units, which can vary greatly depending on the specific section of the conveying line.

The movement of the transport units can take place in sections at a constant speed. In the transfer between sections with different speeds or from sections in which the transport units are at rest, accelerations may be desired in the conveying direction that accelerate the transport units over a short distance.

These requirements also apply in the case where the overhead conveyor device represents a module of a conveyor system, wherein the transport units or the products to be conveyed are transferred from the overhead conveyor device to a following overhead conveyor device. In this case, a movement of the transport units matched to the requirements of the following overhead conveyor device is advantageous at the transfer point.

It is therefore an object of the invention, to improve the prior art of overhead conveyor devices, in particular with regard to the movement of the transport units.

This object is achieved by the features of the independent claims. Preferred embodiments of the invention are given in the dependent claims and in the present description and the drawings.

The invention relates to a transport unit of an overhead conveyor device, comprising an elastically deformable buffer element, which is configured such that it stores deformation energy when loaded and releases the latter again when the load is removed.

In a preferred embodiment, the buffer element is configured such that it performs mechanical work with the released deformation energy.

Usually, a large number of transport units move along a conveying line in an overhead conveyor device. These transport units can be arranged close beside another or abut against one another in buffer or accumulation sections.

It can frequently be the case that the transport units collide with one another at relatively high speeds, before they are decelerated or come to rest in the buffer or accumulation sections. The buffer element offers the advantage here that, when a transport unit collides with another transport unit, the kinetic energy of the collision can be converted into deformation energy and be absorbed by the buffer element. The buffer element can thus serve as a damper, which has a protective effect on the transport units and prevents noise.

Since the buffer element is elastically deformable, the buffer element can at least in part return back into its original shape when the load is removed and thus serve again as a damper when a further collision of the transport unit occurs.

Deformation is also understood in connection with this disclosure to mean a compression of the buffer element.

The buffer element is configured in such a way as to perform mechanical work with the deformation energy released when the load is removed again. In particular, acceleration work, preferably for accelerating a transport unit, can be performed as a result of the buffer element returning to its original shape.

A further advantage of the buffer element is that the mechanical work can be performed by the deformation energy stored in the deformed buffer element without an additional supply of external drive energy being required in the performance of the mechanical work.

The deformation energy is supplied to the buffer element by the fact that the buffer element is deformed, wherein the buffer element of a transport unit is preferably deformed by the abutment of another transport unit or other transport units by means of the mass thereof.

In a variant, an additional external energy source is provided for performing the mechanical work, preferably for moving the transport units, wherein the deformation energy released by the buffer element can be used in addition to the external energy source.

For example, an incline can be formed along a conveying line of the overhead conveyor device, wherein the transport units can be moved by being driven by gravity thanks to the incline.

Alternatively or in addition, a drive, e.g. a chain drive, can be provided as an external energy source.

In a preferred embodiment of the transport unit, the buffer element is deformable when loaded in such a way that the stored deformation energy is sufficient, when the deformation energy is released and the buffer element has preferably returned to its original unloaded shape, to accelerate a transport unit along a conveying line of the overhead conveyor device.

This is particularly advantageous when a plurality of transport units abut against one another essentially at rest in a section of the overhead conveyor device, preferably in an accumulation line, and the transport units are accelerated out of this section. The buffer element according to the invention offers the advantage that specific accelerations for limited collision processes, which may be desired in different sections of a conveying line, can be achieved by the release of the deformation energy stored in the buffer element without an additional external supply of energy.

In the case of a series of transport units which are abutting against one another in an accumulation line in such a way that the buffer elements are deformed, the foremost transport unit can for example be accelerated in the direction of the conveying line with the return of the foremost deformed buffer element into its original shape.

In the case of a series of transport units, this offers the advantage that the mechanical work can be used for isolating, in particular, the first transport units from the following transport units and for accelerating the isolated transport units.

A further advantage is that the mechanical work can be used for separating transport units from a series of transport units.

For example, in the case of a series of transport units which are coupled, the transport units can first be separated and then be isolated into single units.

In an embodiment, the deformation energy stored by the buffer element, when released, is sufficient to accelerate a mass between 0.01 kg and 5 kg, over a distance of the length of one to two transport units, to a speed between 30-100% of the average conveying speed of the overhead conveyor device.

The mass to be accelerated can be a transport unit with goods to be transported or a transport unit alone. If mention is made generally of a transport unit in this application, a transport unit with goods is thus preferably intended.

After they have been accelerated to 30-100% of the average conveying speed, the transport units are preferably moved onward by means of drives, such as for example chain drives, or are driven by gravity on inclined conveying lines.

The buffer element offers the advantage that on the one hand it can serve as a damper during collision processes of transport units and on the other hand can accelerate the transport units in acceleration processes.

In a preferred embodiment, the buffer element is constituted in one piece.

A one-piece embodiment of the buffer element offers the advantage that the production is straightforward and cost-effective.

In an embodiment, the buffer element is made at least partially of plastic.

The buffer element is preferably produced from foam. A buffer element made of foam offers the advantage that recoil forces are small in the event of a deformation due to loading of the buffer element. Especially in the case of a collision of transport units, it is advantageous if the kinetic energy of the collision is absorbed by deformation of the buffer element without the transport units repeatedly colliding heavily with one another due to large rebounds before they come to rest.

In a variant, the buffer element can be produced at least partially from rubber.

In further variants, the buffer element can be produced at least partially from a spring-elastic, preferably metallic, material.

In an embodiment, the buffer element can be connected detachably to the transport unit.

This offers the advantage that the buffer element can easily be replaced. This is advantageous if the buffer element becomes damaged, or if buffer elements with specific deformation strengths are desired for specific conveying applications, which buffer elements can be exchanged in each case for the specific application.

Deformation strength is understood to be the extent of the deformation of the buffer element with a given load. A buffer element with a high deformation strength will be less deformed with identical loading than a buffer element with a low deformation strength.

If no buffer elements are required or desired for a specific conveying application, this detachable connection offers the further advantage that the buffer elements can simply be removed and the transport units can be used without the buffer elements.

In further embodiments, the buffer element can be connected to the transport unit detachably in a form-fit and/or force-fit manner and/or in a materially bonded manner.

In certain embodiments, the buffer element can be connected detachably to the transport unit by means of brackets and/or recesses and/or hooks and/or pins in a form-fit and/or force-fit manner and/or with adhesives in a materially bonded manner.

In an embodiment, the buffer element comprises a first leg and a second leg projecting from the first leg, which legs are connected by a link section in such a way that the legs can be moved towards one another when the buffer element is loaded.

The buffer element with a first and second leg offers the advantage that, in addition to the material property of the buffer element, e.g. the intrinsic deformation properties of foam, the storage of the deformation energy can be assisted by the geometry of the buffer element.

The link section is optionally constituted elastically deformable, so that the link section can absorb deformation energy.

The embodiment with a first and second leg offers the further advantage that any forces occurring due to the deformation can be localised inside the buffer element and are not exerted in an undesirable way on components of the transport unit, such as for example gripper elements.

When the buffer element is loaded, the second leg preferably moves so far towards the first leg until it abuts against the first leg or until the two legs are arranged essentially parallel with one another.

In an embodiment, the first leg and the second leg are also connected by at least one bridge, wherein the at least one bridge is deformable when the buffer element is loaded.

The second leg optionally has cutouts in cross-section, which are bounded by further bridges inside the second leg. These cutouts and bridges can also advantageously absorb deformation energy when the buffer element is loaded.

The bridges can have a predetermined folding point, so that when the buffer element is loaded a bridge can be folded at the predetermined folding point and, for example, can thus damp a collision.

In an embodiment, the first leg can be connected detachably to the transport unit. In this embodiment, the buffer element can be fitted to a transport unit by the fact that the first leg is connected detachably to the transport unit. The first leg advantageously remains unchanged with regard to its shape and position in the presence of loading, whereas the second leg is moved towards the first leg by deformation of the bridge and/or the link section.

In an embodiment, the buffer element has a D-shaped cross-section.

A D-shaped cross-section offers the advantage of a simple shape of the buffer element, which is suitable both for sufficient damping and also for storage and release of deformation energy.

In further embodiments, the buffer element comprises an optically visible, preferably coloured, marking to identify the buffer element.

The marking can serve to identify the usage date of the buffer element on the transport unit. The marking offers the advantage that, for example, the usage date of the buffer element can easily be recognised and a replacement can be made when required, e.g. after a period in use specified by the manufacturer and limited by material-related wear.

Alternatively or in addition, the marking can serve to differentiate between buffer elements with different deformation strengths.

In an embodiment, the buffer element is arranged on one side of the transport unit. When the transport unit is abutting against another, preferably following transport unit, the buffer element is arranged and loaded between the two transport units.

In an embodiment, the buffer element is arranged on the side of the transport unit orientated in the conveying direction or on the side opposite to the conveying direction. If the buffer element is arranged on a side of the transport unit orientated opposite to the conveying direction, the transport unit can push itself away from a following abutting transport unit by the release of the deformation energy of the buffer element. If the buffer element is arranged on a side of the transport unit orientated towards the conveying direction, the transport unit can push a transport unit lying ahead, against which the transport unit is abutting, by the release of the deformation energy of the buffer element. The terms “lying ahead” and “following” are understood here in relation to the conveying direction.

In a variant, a buffer element is arranged on the side of the transport unit orientated in the conveying direction and a further buffer element is arranged on the side of the transport unit opposite to the conveying direction.

In a further variant, two buffer elements are arranged on a transport unit, preferably on two sides lying mutually opposite, one in the conveying direction and one opposite to the conveying direction, wherein the transport units with two buffer elements are arranged between transport units without buffer elements.

In an embodiment, the transport unit comprises a receptacle, which serves to enter into a detachable connection with the buffer element.

The receptacle can comprise brackets and/or recesses and/or hooks and/or pins.

In further embodiments, the transport unit is a carriage freely movable in a running rail.

In a further embodiment, the carriage comprises grippers.

The embodiment as a carriage with grippers is particularly advantageous for conveying printed products. Especially in the production of, preferably addressee-specific, printed product collections, it often happens that the transport units have to be decelerated or accelerated along the conveying line. A transport unit with a buffer element according to the present disclosure is therefore particularly well suited for such applications.

The buffer element preferably has a spring constant k between 0.1 N/m and 1000 N/m for masses m between 0.01 and 5 kg to be accelerated (i.e. transport unit and good or transport unit alone).

For masses between 0.5 kg and 2 kg to be accelerated, the buffer element preferably has a spring constant k between 2 N/m and 500 N/m, particularly preferably between 10 N/m and 50 N/m.

Spring constant k preferably behaves with respect to mass m to be accelerated in such a way that mass m can already be accelerated to 30-100% of the average conveying speed due to the effect of the buffer element.

The characterisation of the buffer element by the spring constant preferably takes place for a linear range or for a linear component of the elastic deformability of the buffer element.

The person skilled in the art is aware that there can also be a non-linear range of the elastic deformability. According to specific embodiments, the characterisation of the buffer element is not limited to a linear range, but can also be applied accordingly to the non-linear range.

In an embodiment, the transport unit comprises a separate damping element and a separate spring element. In this context, a spring element is understood to mean an elastically deformable buffer element, which has a spring constant k, which behaves with respect to mass m to be accelerated in such a way that mass m can be accelerated to 50-100% of the average conveying speed. A damping element is understood to mean an elastically deformable buffer element, the main task whereof lies in damping or deceleration and, compared to the spring element described above, accordingly has a spring constant k which behaves with respect to mass in to be accelerated in such a way that mass in is accelerated to less than 50% of the average conveying speed.

The invention also relates to an overhead conveyor device with a transport unit. The overhead conveyor device comprises a delivery point of the transport units and a barrier element arranged at the delivery point, wherein the barrier element is configured to selectively block or release the transport units.

In an embodiment, the overhead conveyor device comprises an accumulation line, which is arranged upstream preferably directly at the delivery point of the transport units. The transport units are preferably at rest in the accumulation line or are conveyed at a reduced speed.

The accumulation line can advantageously be used for isolating into single units and/or separating goods or transport units or for commissioning. Isolating of goods or transport units from the accumulation line into single units is a known problem in intra-logistics. The overhead conveyor device according to the invention is particularly well suited for simplifying the isolating of goods or transport units from the accumulation line into single units.

In an embodiment, a plurality of parallel accumulation lines is provided, which can be used for the pre-sorting or separating-out of goods or transport units. This embodiment is particularly advantageous for a batch operation, e.g. when conveying cloths on clothes hangers.

In the parallel accumulation lines, gate systems are preferably provided, which are able to split up and/or bring together the flow of products/goods.

In an embodiment, a higher-level control device is provided, which controls the delivery and/or the splitting-up and/or the feeding and/or the loading of the transport units.

Whether and which goods are to be brought together can also be controlled by the control device.

The transport units can advantageously be held back in the accumulation line by blocking by means of the barrier element and, when required, can be released again by the barrier element.

In a preferred embodiment, transport units following one another abut against one another when the first transport unit is blocked in the conveying direction by the barrier element, in such a way that at least one buffer element is loaded. The overhead conveyor device is preferably configured at the delivery point of the transport units so as to remove the load on the at least one loaded buffer element when the transport units are released by the barrier element, in such a way that the buffer element accelerates at least the first transport unit in the conveying direction.

In an embodiment, the overhead conveyor device is configured at the delivery point of the transport units so as to remove the load on the loaded buffer element when the transport units are released by the barrier element, in such a way that the buffer element accelerates the transport units in each case sequentially in the conveying direction.

A buffer element of a transport unit which is blocked by the barrier element is usually loaded by the mass of the following transport units, which are abutting against the transport unit. The totality of the following transport units forms a kind of abutment, at which a transport unit can push itself away when the load is removed from a deformed buffer element.

An incline of the section of the conveying line in which the transport units abut against one another on account of the blocking of the barrier element at the delivery point of the transport units optionally contributes towards the loading of the buffer elements and towards the build-up of deformation energy.

This embodiment is therefore advantageous inasmuch as the deformation energy does not have to be supplied externally in addition (e.g. by a mechanical drive), but can in particular be made available by the mass of the following transport units with or without goods.

The barrier element offers the further advantage that the release and unloading of the transport units can be initiated in a controlled manner. Upon release, a transport unit or a specific provided number a transport units is advantageously accelerated to a designated speed, wherein the transport unit or the specific number of transport units leaves the delivery point of the transport units.

The following transport units abutting against these transport units can contribute by their mass to the acceleration. The buffer element, which performs the acceleration work through the release of the deformation energy when the load is removed, offers the advantage however that an additional acceleration of the transport units is enabled without an additional supply of external energy (e.g. by a mechanical drive), which can be decisive for the further conveying of the transport units.

This is particularly advantageous in the case where the transport units have to be accelerated from rest from an accumulation line and their inertia has to be overcome. For transport units without a buffer element, the mass of the following transport units may be insufficient, even with an inclined accumulation line, to accelerate the transport units sufficiently quickly to a required speed.

In an embodiment of the overhead conveyor device, a cyclic feed device is arranged at the delivery point of the transport units, said cyclic feed device serving to feed the transport units in a synchronised manner into a section of the overhead conveyor device following the delivery point of the transport units. The cyclic feed device can take over the transport units that have been accelerated out of the delivery point of the transport units and transfer them to the following section.

A minimum speed of the transport units is advantageous for an efficient take-over of the transport units into the cyclic feed device, which is enabled by the buffer elements according to the invention.

In an embodiment, the cyclic feed device is a screw conveyor.

The overhead conveyor system according to the present disclosure is particularly well suited for a preparation circuit in a print finishing system. In the production of, in particular addressee-specific, printed product collections, a controlled retention and delivery of transport units with specific print products is advantageous.

Usually, the transport units are transferred at the delivery point of the transport units, e.g. of the preparation circuit, to a following overhead conveyor device, e.g. a delivery conveyor. A cyclic feed device, e.g. a screw conveyor, can take over the transport units from the accumulation line, wherein a minimum speed of the transport units at the delivery point of the transport units is advantageous for an efficient take-over.

The buffer element offers the advantage that the transport units at the delivery point of the transport units can be accelerated to a minimum speed in order to ensure a fault-free take-over of the transport units by the screw conveyor, wherein a further advantage consists in the fact that the buffer element can achieve this without an additional external energy supply (e.g. by a mechanical drive).

In an embodiment, the overhead conveyor device comprises a running rail, wherein the running rail has inclines in sections such that the transport units can be driven by gravitation.

The running rail is preferably inclined upstream of the delivery point of the transport units in such a way that the transport units can be driven by gravitation.

The incline of the running rail advantageously contributes to the loading of the buffer elements and to the acceleration of the transport units.

In an embodiment, the overhead conveyor device comprises an active acceleration element, which in combination with the buffer element contributes to the acceleration of the transport units at the delivery point of the transport units.

The active acceleration element offers the advantage that the flexibility of the embodiment of the overhead conveyor device can be increased.

In an embodiment, the active acceleration element is a synchronizing wheel. An active acceleration element in the form of a synchronizing wheel offers the advantage that, in addition to the acceleration, cyclic feeding of the transport units is enabled.

In an embodiment, the overhead conveyor device comprises external drives in sections, by means of which the transport units can be driven.

The external drives can be chain drives.

Optionally, external drives are arranged at the delivery point of the transport units and contribute to the loading of the buffer elements and to pushing the transport units.

The overhead conveyor device according to the invention offers the advantage of a robust, stable device which does not require costly monitoring, in particular with regard to the transfer of transport units or the conveyed products from the delivery point to a following overhead conveyor device, which can take place without a supply of additional external energy (e.g. by a mechanical drive).

The invention also relates to a method for operating an overhead conveyor device according to the present disclosure, comprising the steps: i) take-up of products by the transport units at a take-up point of the overhead conveyor device; ii) transport of the products to the delivery point of the transport units; iii) blocking of the transport units at the delivery point by the barrier element, wherein at least one buffer element is loaded by the abutting of the transport units; iv) release of at least one transport unit by the barrier element, wherein the load is removed from at least one buffer element and at least the first transport unit is accelerated in the conveying direction by mechanical work of the at least one buffer element.

In an embodiment, the transport units are separated and/or isolated into single units and/or accelerated sequentially in the conveying direction by mechanical work of the buffer elements in step iv).

In an embodiment, the method is characterised by the additional steps: v) delivery of the products from the transport units; vi) return of the empty transport units to the take-up point of the overhead conveyor device.

In an embodiment, the method is characterised by the additional step: vii) deceleration of the transport units before the take-up point by loading the buffer elements with the abutting of the transport units.

### BRIEF DESCRIPTION OF SEVERAL VIEWS OF THE DRAWINGS

Embodiments of the invention are explained in greater detail with the aid of the following figures and the associated descriptions. In the figures:

FIG. 1 shows a perspective view of an embodiment of a transport unit with a buffer element;

FIG. 2A shows a perspective view of a transport unit from FIG. 1 without a buffer element;

FIG. 2B shows a perspective view of the buffer element from FIG. 1;

FIG. 2C shows a perspective view of an embodiment of a buffer element;

FIG. 2D shows a perspective view of a further embodiment of a buffer element;

FIG. 3 shows a side view of a section of an embodiment of an overhead conveyor device with a series of transport units according to FIG. 1;

FIG. 4 shows a side view of a section of an embodiment of an overhead conveyor device with a series of transport units according to FIG. 1;

FIG. 5 shows a perspective view of an embodiment of an overhead conveyor device.

### DETAILED DESCRIPTION OF THE INVENTION

Preferred embodiments are described in greater detail by reference to the figures in order to illustrate the invention.

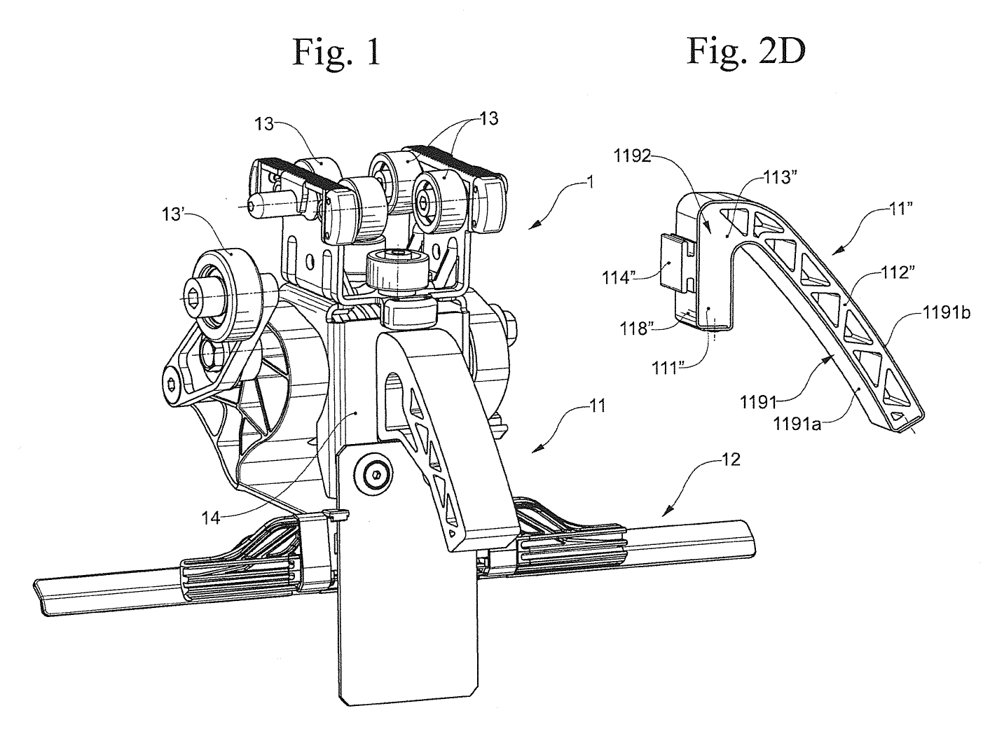

FIG. 1 shows a perspective view of an embodiment of a transport unit 1. Transport unit 1 comprises a buffer element 11, which is fitted to a face 14 of transport unit 1. The buffer element 11 is shown in an unloaded state. In the shown embodiment, transport unit 1 is a carriage with rollers 13 and 13′ as well as a gripper 12. The shown transport unit 1 is particularly suitable for conveying printed products which can be taken up by gripper 12. Opening or closing of gripper 12 can be achieved in a known manner with a suitable crank, over which roller 13′ runs.

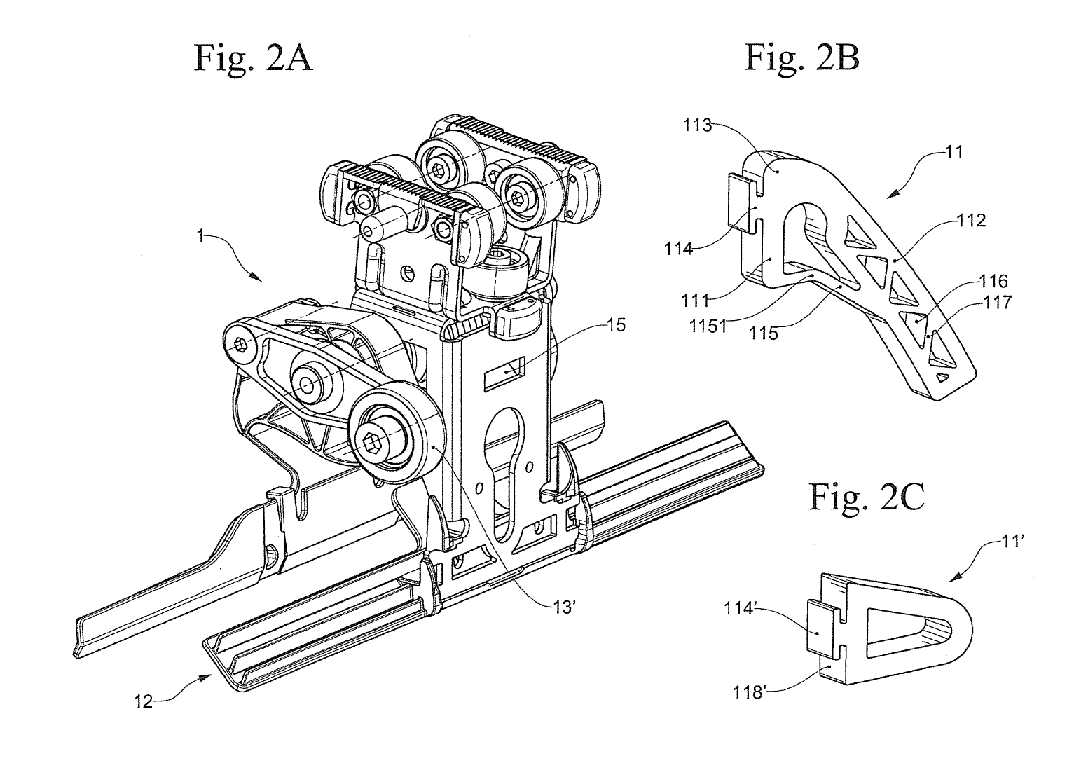

FIG. 2A shows a perspective view of transport unit 1 from FIG. 1 without a buffer element. A receptacle 15 can be seen at the point at which the buffer element was fitted in FIG. 1, into which receptacle a bracket of the buffer element can be inserted. Gripper 12 is shown in an opened position, which has been brought about by a movement of roller 13′ compared to FIG. 1.

FIG. 2B shows a perspective view of buffer element 11 from FIG. 1. Buffer element 11 comprises a first leg 111 and a second leg 112, which are connected by a link section 113. Buffer element 11 is shown in an unloaded state. A bracket 114 is arranged on first leg 111, which can be inserted into receptacle 15 from FIG. 2A and by means of which buffer element 11 can be connected detachably to transport unit 1. First leg 111 and second leg 112 are also connected via a bridge 115, wherein bridge 115 has a predetermined folding point 1151. When buffer element 11 is loaded, bridge 115 is deformed, wherein bridge 115 can be folded at predetermined folding point 1151. Second leg 112 comprises cutouts 116, which are bounded by further bridges 117. Buffer element 11 is constituted in one piece. Buffer element 11 is preferably made of foam.

FIG. 2C shows an embodiment of a buffer element 11′, which has a D-shaped cross-section. A bracket 114′ is arranged on a face 118′ of buffer element 11′, by means of which bracket buffer element 11′ can be connected detachably to a transport unit. Buffer element 11′ is constituted in one piece and is preferably made of foam.

FIG. 2D shows an embodiment of a buffer element 11″, which comprises a spring plate 1191 and a foam core 1192. Spring plate 1191 comprises two leaf elements 1191a, 1191b, which are arranged adjacent to foam core 1192 at the periphery. A bracket 114″ is arranged at a face 118″ of spring plate 1191, by means of which bracket buffer element 11″ can be connected detachably to a transport unit. Buffer element 11″ comprises a first leg 111″ and a second leg 112″, which are connected by a link section 113″. Buffer element 11″ is shown in an unloaded state. When buffer element 11″ is loaded, second leg 112″ moves towards first leg 111″ and thus absorbs the deformation energy. A buffer element 11″ with a spring plate 1191, as is shown in the figure, has in particular ideal properties with regard to the acceleration work that can be performed by buffer element 11″, and in particular a high acceleration even of large masses can be achieved by a high spring constant k of spring plate 1191.

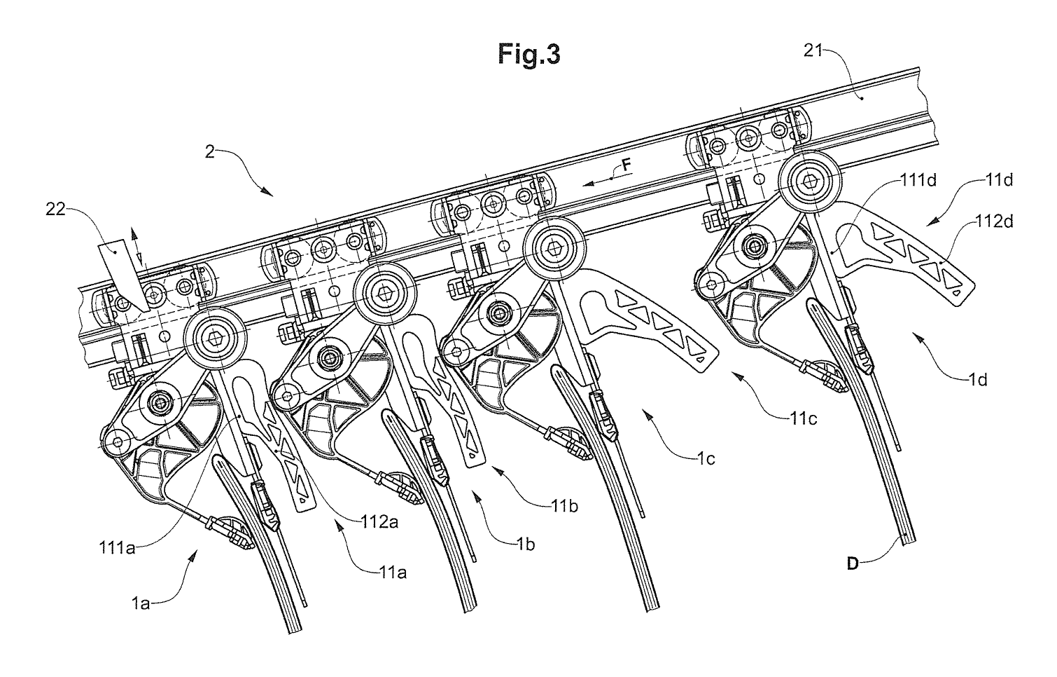

FIG. 3 shows a side view of a section of an embodiment of an overhead conveyor device 2 with a running rail 21 and a barrier element 22. Four transport units 1a-d according to FIG. 1 are shown in the figure, wherein the three foremost transport units 1a-c are abutting against one another in conveying direction F. Transport units 1a-d are shown with printed products D. Buffer elements 11a, b of the front two transport units 1a, b are shown in the loaded state, in which buffer elements 11a, b are deformed. Second leg 112a of deformed buffer element 11a has been moved towards first leg 111a and is arranged essentially parallel to the latter. Buffer elements 11c, d of third transport unit 1c and fourth transport unit 1d are shown in the unloaded state, in which buffer elements 11c, d are not deformed. In the unloaded state, second leg 112d is arranged projecting from first leg 111d. Transport units 1a-1c are abutting against one another, because barrier element 22 prevents further movement of transport unit 1a in conveying direction F. Barrier element 22 can be moved up and down in the vertical direction relative to running rail 21, which is indicated by the double arrow. Transport unit 1a can move farther in conveying direction F by an upward movement of barrier element 22.

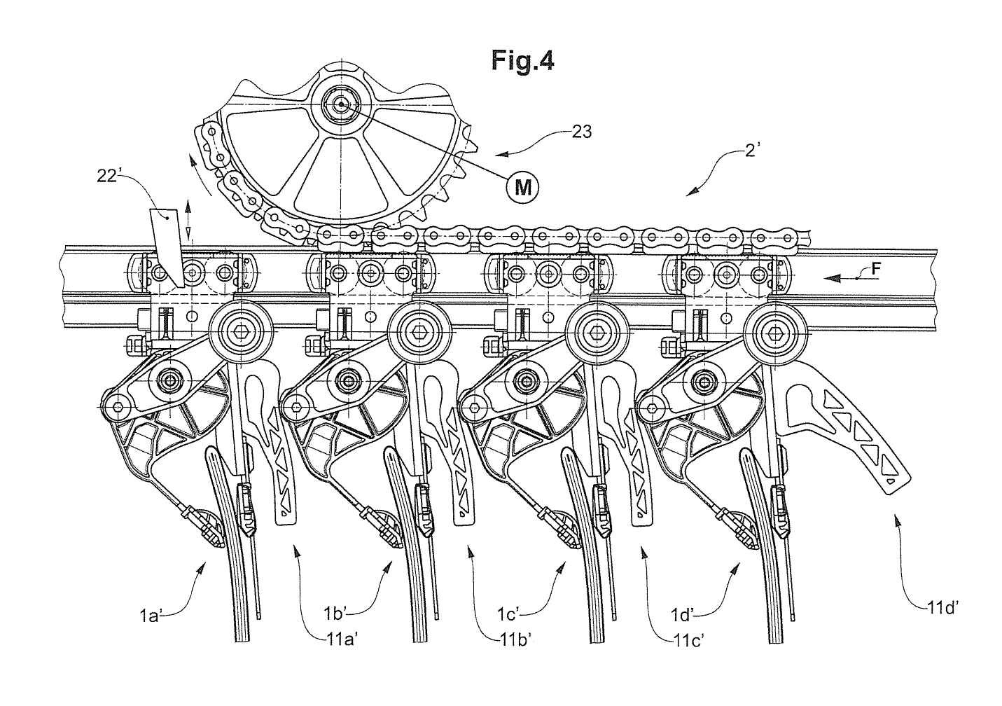

FIG. 4 shows a side view of a section of an embodiment of an overhead conveyor device 2′ with a series of transport units 1a′-d′ according to FIG. 1. Transport units 1a′-d′ are driven by a chain drive 23. A movement of transport unit 1a′ in conveying direction F is blocked by barrier element 22′, so that following transport units 1b′-d′ abut against one another. Buffer elements 11a′-11c′ are shown deformed in the loaded state, buffer element 11d′ being shown in the unloaded state.

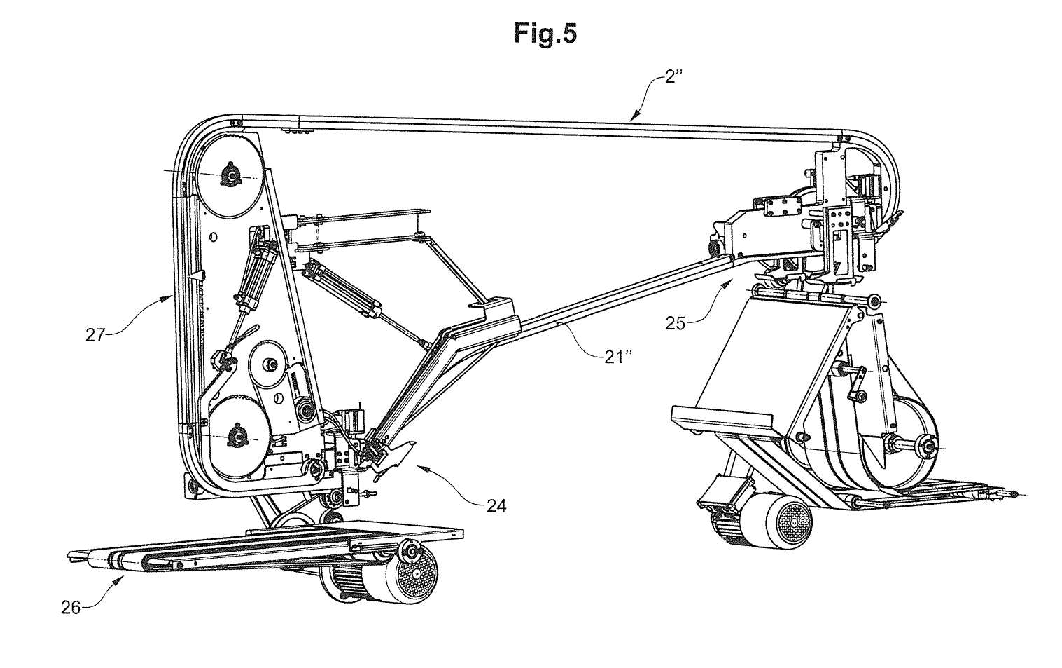

FIG. 5 shows a perspective view of an embodiment of an overhead conveyor device 2″ without transport units. Overhead conveyor device 2″ comprises a running rail 21″, a take-up point 25, a delivery point 24, a delivery conveyor 26 and a return section 27. Running rail 21″ is constituted inclined in sections, in particular towards delivery point 24, so that transport units can be driven by gravitation in these sections. Arranged at the delivery point is a barrier element (not shown in the figure), by means of which transport units can be blocked. Buffer elements of the transport units can be loaded by following transport units by means of the mass thereof. As a result of acceleration from delivery point 24, the transport units move on a section parallel to a delivery conveyor 26, on which the transport units can deliver products, e.g. printed products. The empty transport units are moved back to take-up point 25 via return section 27. At take-up point 25, the empty transport units can take up products and be moved to delivery point 24.

1. A transport unit (1, 1a-d, 1a′-d′) of an overhead conveyor device (2, 2′, 2″), comprising:
an elastically deformable buffer element (11, 11′, 11″, 11a-d, 11a′-d′) arranged with respect to the transport unit (1, 1a-d, 1a′-d′), and configured to store deformation energy when loaded and to release the deformation energy when the load is removed.

2. The transport unit (1, 1a-d, 1a′-d′) according to claim 1, wherein the buffer element (11, 11′, 11″, 11a-d, 11a′-d′) is configured to perform mechanical work with the released deformation energy.

3. The transport unit (1, 1a-d, 1a′-d′) according to claim 2, wherein the buffer element (11, 11′, 11″, 11a-d, 11a′-d′) is deformable when loaded in such a way that the stored deformation energy is sufficient, when the deformation energy is released and the buffer element (11, 11′, 11″, 11a-d, 11a′-d′) has returned to its original unloaded shape, to accelerate a transport unit (1, 1a-d, 1a′-d′) along a conveying line of the overhead conveyor device (2, 2′, 2″).

4. The transport unit (1, 1a-d, 1a′-d′) according to claim 1, wherein the buffer element (11, 11′, 11″, 11a-d, 11a′-d′) is constituted in one piece.

5. The transport unit (1, 1a-d, 1a′-d′) according to claim 1, wherein the buffer element (11, 11′, 11″, 11a-d, 11a′-d′) is made at least partially of plastic.

6. The transport unit (1, 1a-d, 1a′-d′) according to claim 1, wherein the buffer element (11, 11′, 11″, 11a-d, 11a′-d′) comprises a first leg (111, 111″, 111a-d) and a second leg (112, 112″, 112a-d) projecting from the first leg (111, 111″, 111a-d), which legs are connected by a link section (113, 113″) in such a way that the legs can be moved towards one another when the buffer element (11, 11′, 11″, 11a-d, 11a′-d′) is loaded.

7. The transport unit (1, 1a-d, 1a′-d′) according to claim 6, wherein the first leg (111, 111a-d) and the second leg (112, 112a-d) are also connected by at least one bridge (115), wherein the at least one bridge (115) is deformable when the buffer element (11, 11′, 11″, 11a-d, 11a′-d′) is loaded.

8. The transport unit (1, 1a-d, 1a′-d′) according to claim 1, wherein the buffer element (11, 11′, 11″, 11a-d, 11a′-d′) comprises an optically visible marking to identify the buffer element (11, 11′, 11″, 11a-d, 11a′-d′).

9. The transport unit (1, 1a-d, 1a′-d′) according to claim 1, wherein the buffer element (11, 11′, 11″, 11a-d, 11a′-d′) is detachably connected to the transport unit (1, 1a-d, 1a′-d′).

10. The transport unit (1, 1a-d, 1a′-d′) according to claim 1, wherein the buffer element (11, 11′, 11″, 11a-d, 11a′-d′) is arranged on one side (14) of the transport unit (1, 1a-d, 1a′-d′), wherein, when the transport unit (1, 1a-d, 1a′-d′) is abutting against another, preferably following transport unit (1, 1a-d, 1a′-d′), the buffer element (11, 11′, 11″, 11a-d, 11a′-d′) is arranged and loaded between the two transport units (1, 1a-d, 1a′-d′).

11. The transport unit (1, 1a-d, 1a′-d′) according to claim 10, wherein the buffer element (11, 11′, 11″, 11a-d, 11a′-d′) is arranged on the side (14) of the transport unit (1, 1a-d, 1a′-d′) orientated in the conveying direction (F) or opposite to the conveying direction (F).

12. The transport unit (1, 1a-d, 1a′-d′) according to claim 1, wherein the transport unit (1, 1a-d, 1a′-d′) is a carriage freely movable in a running rail (21, 21″).

13. An overhead conveyor device with a transport unit (1, 1a-d, 1a′-d′) according to claim 1, wherein the overhead conveyor device (2, 2′, 2″) comprises a delivery point (24) of the transport units (1, 1a-d, 1a′-d′) and a barrier element (22, 22′) arranged at the delivery point (24), wherein the barrier element (22, 22′) is configured to selectively block or release the transport units (1, 1a-d, 1a′-d′).

14. The overhead conveyor device (2, 2′, 2″) according to claim 13, wherein transport units (1, 1a-d, 1a′-d′) following one another abut against one another when the first transport unit (1, 1a, 1a′) is blocked in the conveying direction (F) by the barrier element (22, 22′), so that at least one buffer element (11, 11′, 11″, 11a-d, 11a′-d′) is loaded, and that the overhead conveyor device (2, 2′, 2″) is configured at the delivery point (24) of the transport units (1, 1a-d, 1a′-d′) to remove the load on the at least one loaded buffer element (11, 11′, 11″, 11a-d, 11a′-d′) when the transport units (1, 1a-d, 1a′-d′) are released by the barrier element (22, 22′), so that the buffer element (11, 11′, 11″, 11a-d, 11a′-d′) accelerates at least the first transport unit (1, 1a, 1a′) in the conveying direction (F).

15. The overhead conveyor device (2, 2′, 2″) according to claim 13, wherein the overhead conveyor device (2, 2′, 2″) comprises a running rail (21, 21″), wherein the running rail (21, 21″) includes inclines in sections such that the transport units (1, 1a-d, 1a′-d′) can be driven by gravitation.

16. The overhead conveyor device (2, 2′, 2″) according to claim 13, wherein the overhead conveyor device (2, 2′, 2″) comprises external mechanical drives in sections, by means of which the transport units (1, 1a-d, 1a′-d′) can be driven.

17. A method for operating an overhead conveyor device (2, 2′, 2″) according to claim 13, comprising the steps:
i) take-up of products by the transport units (1, 1a-d, 1a′-d′) at a take-up point (25) of the overhead conveyor device (2, 2′, 2″);
ii) transport of the products to the delivery point (24) of the transport units (1, 1a-d, 1a′-d′);
iii) blocking of the transport units (1, 1a-d, 1a′-d′) at the delivery point (24) by the barrier element (22, 22′), wherein at least one buffer element (11, 11′, 11″, 11a-d, 11a′-d′) is loaded by the abutting of the transport units (1, 1a-d, 1a′-d′); and
iv) release of at least one transport unit (1, 1a-d, 1a′-d′) by the barrier element (22, 22′), wherein the load is removed from at least one buffer element (11, 11′, 11″, 11a-d, 11a′-d′) and at least the first transport unit (1, 1a, 1a′) is accelerated in the conveying direction (F) by mechanical work of the at least one buffer element (11, 11′, 11″, 11a-d, 11a′-d′).

18. The method according to claim 17, further comprising the additional steps:
v) delivery of the products from the transport units (1, 1a-d, 1a′-d′); and
vi) return of the empty transport units (1, 1a-d, 1a′-d′) to the take-up point (25) of the overhead conveyor device (2, 2′, 2″).
